(19) United States
(12) Patent Application Publication
(10) Pub. No.: US 2011/0030338 A1
(43) Pub. Date: Feb. 10, 2011

(54) BYPASS TURBOJET ENGINE NACELLE

(75) Inventor: Guy Bernard Vauchel, Harfleur (FR)

Correspondence Address: CANTOR COLBURN LLP, 20 Church Street, 22nd Floor, Hartford, CT, 06103, US

(73) Assignee: AIRCELLE, Gonfreville L'Orcher (FR)

(21) Appl. No.: 12/937,462

(22) PCT Filed: Apr. 9, 2009
(86) PCT No.: PCT/FR09/50643

§ 371 Date: Oct. 12, 2010

(30) Foreign Application Priority Data
Apr. 14, 2008 (FR) 0802036

(51) Int. Cl. F02K 3/02

(52) U.S. Cl. 60/226.2

(57) ABSTRACT

The invention relates to a bypass turbojet engine nacelle comprising a downstream section equipped with a thrust reverser device comprising a moving cowl (6) mounted such that it can move in translation in a direction substantially parallel to a longitudinal axis of the nacelle and able to move alternately from a closed position in which it ensures the aerodynamic continuity of the nacelle and covers deflection means (70) and an open position in which it opens a passage in the nacelle and uncovers the deflection means, the said moving cowl also being extended by at least one nozzle section (7) mounted at a downstream end of the said moving cowl, characterized in that the nozzle section comprises at least one panel (10) mounted such that it can rotate about at least one pivot about an axis substantially perpendicular to a longitudinal axis of the nacelle, the said panel further being connected to a fixed fairing structure (2) of the turbojet engine by at least one link rod (11) mounted such that it can rotate about anchor points on the panel of the nozzle section and on the fixed structure, respectively.

### TECHNICAL FIELD

The invention concerns a turbojet nacelle comprising a variable nozzle section.

### BACKGROUND

An airplane is moved by several turbojet engines each housed in a nacelle also housing a set of connected actuating devices related to its operation and performing various functions when the turbojet engine is in operation or stopped. These related actuating devices comprise in particular a mechanical system for actuating thrust reversers.

A nacelle generally has a tubular structure comprising an air inlet upstream from the turbojet engine, a middle section designed to surround a fan of the turbojet engine, a downstream section housing thrust reverser means and designed to surround the combustion chamber of the turbojet engine, and generally ends with a jet nozzle whereof the outlet is situated downstream from the turbojet engine.

Modern nacelles are designed to house a bypass turbojet engine capable of generating, via the rotating fan blades, a stream of hot air (also called primary stream) coming from the combustion chamber of the turbojet engine, and a stream of cold air (secondary stream) that circulates outside the turbojet engine through an annular passage, also called a tunnel, formed between a cowl of the turbojet engine and an inner wall of the nacelle. The two air streams are ejected from the turbojet engine through the rear of the nacelle.

The role of a thrust reverser is, during landing of an airplane, to improve the braking capacity thereof by reorienting at least part of the thrust generated by the turbojet engine forward. In this phase, the reverser obstructs the cold stream tunnel and orients the latter toward the front of the nacelle, thereby generating a counter-thrust that is added to the braking of the airplane's wheels.

The means implemented to perform this reorientation of the cold flow vary depending on the type of reverser.

Aside from its thrust reverser function, the moving cowl belongs to the rear section and has a downstream side forming a jet nozzle aiming to channel the ejection of the air streams. This nozzle can serve to complement a primary nozzle channeling the hot stream and is then called secondary nozzle.

The moving cowl is thus equipped, as is known from document U.S. Pat. No. 5,806,302, with at least one nozzle moving in relation to said moving cowl, so as to adjust the exhaust section of the annular duct as a function of the position of said nozzle. The moving nozzle is also called moving structure for adjusting the nozzle section.

Each moving portion, i.e. the thrust reverser cowl on one hand, and the moving nozzle on the other, is actuated by a dedicated actuator. This involves the presence of supply and control circuits of the actuators extending inside the moving cowl, which is handicapping from a maintenance and safety perspective.

French application FR 06/05512 also describes a variable nozzle system associated with a grid reverser and the external structure of which completely realizes the external lines of the reverser. This application discloses the use of a telescopic cylinder, a first rod of which is designed to actuate the moving cowl while the second rod is designed to adjust the nozzle. Such a system makes it possible to respond to the issue of centralizing supply and control means at a front frame on which the base of the dual-action actuator is fastened.

Each of these variable nozzles therefore has a relatively complex structure and requires an additional actuating system influencing the reliability and mass of the nacelle assembly.

### BRIEF SUMMARY

The present invention therefore aims to propose a simplified structure that does not require a dedicated actuating member.

To do this, the present invention relates to a bypass turbojet engine nacelle comprising a downstream section equipped with a thrust reverser device comprising a moving cowl mounted such that it can move in translation in a direction substantially parallel to a longitudinal axis of the nacelle and able to move alternately from a closed position in which it ensures the aerodynamic continuity of the nacelle and covers deflection means and an open position in which it opens a passage in the nacelle and uncovers the deflection means, said moving cowl also being extended by at least one nozzle section mounted at a downstream end of said moving cowl, characterized in that the nozzle section comprises at least one panel mounted such that it can rotate about at least one pivot about an axis substantially perpendicular to a longitudinal axis of the nacelle, said panel further being connected to a fixed fairing structure of the turbojet engine by at least one link rod mounted such that it can rotate about anchor points on the panel of the nozzle section and on the fixed structure, respectively.

Thus, by providing one or several pivoting panels constituting the nozzle section and connected by a link rod to a fixed structure, said panels are automatically hinged when the moving cowl is moved in the downstream or upstream directions. In this way, the actuating and control system of the moving cowl also makes it possible to control the nozzle section. The assembly is thus lightened and more reliable, since a single actuating system is implemented.

Of course, the number of link rods depends on the loads and balancing undergone by the concerned panels. One may in particular provide two link rods placed laterally or each near a lateral edge of the nozzle section.

According to a first embodiment, the link rod is mounted obliquely such that one end of said link rod connected to the panel is upstream from an end connected to the fixed structure when the panel is in the cruise position, causing an increase in the nozzle section when the moving cowl is withdrawn.

According to a second embodiment, the link rod is mounted obliquely such that one end of said rod connected to the panel is downstream from an end connected to the fixed structure when the panel is in the cruise position, causing a reduction of the nozzle section when the moving cowl is withdrawn.

Advantageously, the nacelle comprises between four and eight pivoting panels of moving nozzle section. Of course, the number and length of the panels depends on the expected performance goals and is not limited to six panels. The number of six panels makes it possible to optimize aerodynamic loss due to the link rods in the circulation tunnel of the air stream.

Preferably, the articulation of the panel of the pivoting nozzle section is defined in the thickness of streamlines of the downstream end of the moving cowl. Of course, if the streamlines are not thick enough, it is possible to provide an overhang of said lines with an internal or external aerodynamic fairing depending on the chosen kinematics.

Preferably, each panel is articulated around two link rods each connected to said panel of the nozzle section via an articulation point, the two articulation points being spaced apart from each other by a distance substantially corresponding to two thirds of the width of said panel of the moving nozzle section. This makes it possible to preserve better streamline continuity between the moving cowl and the moving nozzle section during maneuvering of the nozzle section.

Advantageously, at least one portion of the nozzle section has a downstream trimming formed by chevrons. Of course, the downstream trimming can also be smooth or coplanar.

Preferably, the moving cowl is extended by a fixed section on each side of each panel of the moving nozzle section, said fixed section being designed to ensure the continuity of streamlines of the downstream section when the panel of the nozzle section is in a cruise position. The presence of such inter-flap extensions makes it possible to respect the streamlines of the nacelle in the cruise position. Of course, the inter-flaps thus formed by the fixed sections can be reduced to their simplest expression or even removed and leave only the nozzle section panels in contact with each other.

Advantageously, said fixed section has at least one lateral shoulder designed to serve as a support for the panel of the moving nozzle section.

Also advantageously, the fixed section comprises sealing means with each corresponding moving nozzle section panel.

Advantageously, the length of the link rod of the nozzle section panel at a fairing structure of the turbojet engine is adjustable. In this way, the length of the link rod can be precisely adapted to the desired amplitude of rotation as a function of the movement of the moving cowl.

Alternatively or as a complement, at least one anchor point of the link rod of the nozzle section panel at a fairing structure of the turbojet engine is adjustable along at least one axial direction of the link rod, and possibly along longitudinal and transverse directions of the nacelle.

### BRIEF DESCRIPTION OF THE DRAWINGS

The present invention will be better understood with the following description, done in reference to the appended diagrammatic drawing, in which:

FIG. 1 is a diagrammatic longitudinal cross-sectional view of a thrust reverser structure equipped with a pivoting nozzle section according to the invention.

FIG. 2 is a diagrammatic transverse cross-sectional illustration of a nozzle section of a nacelle according to the invention comprising a plurality of pivoting nozzle sections.

FIGS. 3 and 4 are side views corresponding to FIG. 2, having nozzle sections in the cruise position and open position, respectively.

FIG. 5 is an enlarged diagrammatic illustration of an area of FIG. 2.

FIGS. 6 to 9 are diagrammatic longitudinal cross-sectional views of the thrust reverser structure of FIG. 1, in a reversing position, a withdrawn position, an opening position of the reverser, and a forward position of the reverser, respectively.

FIGS. 10 to 12 are partial enlarged views of a junction zone between the moving cowl of the thrust reverser and a front frame of the nacelle.

### DETAILED DESCRIPTION

A nacelle is designed to constitute a tubular housing for a bypass turbojet engine (not shown) with a high dilution rate and serves to channel the air streams it generates via the blades of a fan (not shown), i.e. a hot air stream passing through a combustion chamber (not shown) of the turbojet engine, and a cold air stream circulating outside the turbojet engine (F).

A nacelle generally has a structure comprising a forward section forming an air inlet, a middle section surrounding the fan of the turbojet engine, and a downstream section surrounding the turbojet engine and that can comprise a thrust reverser system.

The downstream section comprises an outer structure possibly including a thrust reverser system and an internal fairing structure 2 of the engine defining, with the outer surface, a tunnel 3 designed for circulation of a cold stream F in the case of a bypass turbojet engine nacelle as discussed here.

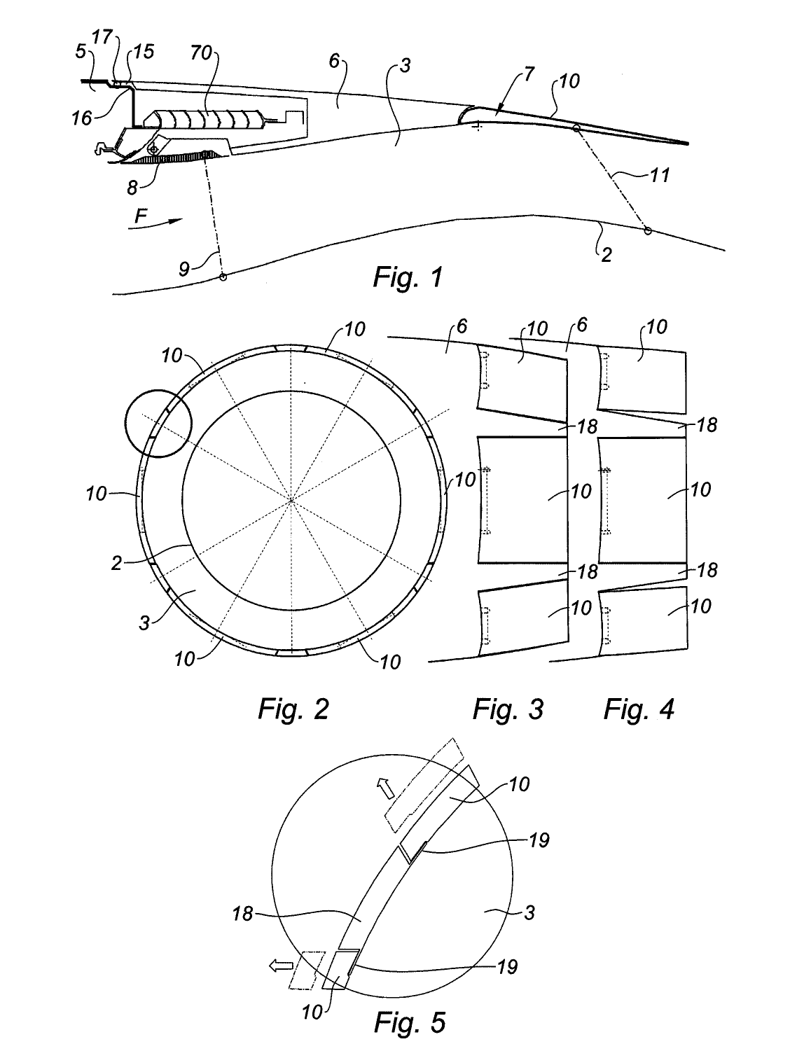

FIG. 1 is a diagrammatic longitudinal cross-sectional illustration of a downstream section equipped with a thrust reverser structure and a pivoting nozzle section according to the invention.

This downstream section comprises a front frame 5, a moving thrust reverser cowl 6, and a nozzle section 7.

Generally, the downstream section comprises two half-portions each equipped with a moving cowl 6.

The moving cowl 6 can be actuated in a substantially longitudinal direction of the nacelle between a closing position in which it comes into contact with the front frame 5 and ensures the aerodynamic continuity of the lines of the downstream section, and an open position in which it is separated from the front frame 5, thereby revealing a passage in the nacelle and uncovering deflection grids 70. When it is opened, the moving cowl 6 drives the rotation of a flap 8 via a link rod 9 fixed in the inner structure 2 of the fairing, said flap at least partially covering the tunnel 3 so as to optimize the inversion of the air stream F.

According to the invention, the nozzle section 7 comprises a plurality of peripheral panels 10 mounted pivoting at a downstream end of the moving cowl 6. As illustrated in FIGS. 2 to 4, the downstream section comprises six moving panels 10 distributed on the periphery of said section, three panels 10 being associated with the moving cowl 6 of the right half-portion and three panels 10 being associated with the moving cowl 6 of the left half-portion.

Advantageously, there will be four to eight nozzle section panels 10.

Each panel 10 is connected by a link rod 11 to the inner fairing structure 2.

Thus, during a movement of the moving cowl 6 in the upstream or downstream direction of the nacelle, the link rod 11 ensures the pivoting of the corresponding panel 10. The movement of the moving cowl 6 therefore allows the adjustment of the panels 10 of the nozzle section 7 without requiring the implementation of a dedicated actuating means and control system.

It follows that the moving cowl 6 must be able to be moved slightly upstream and downstream without causing the reversal or leak of the stream F.

Although the invention is illustrated by an example in which the link rod 11 for actuating the panel 10 is oblique and the end of which connected to the panel is situated upstream from the end connected to the inner structure 2 when the nozzle section is in the cruise position, it is possible to reverse the orientation of said link rod. In that case, a reversal of the moving cowl 6 will cause a reduction in the nozzle section instead of an increase as in the described case.

To do this, the moving cowl 6 has an upstream extension 15 extending above an upper shoulder 16 of the front frame 5 on which it can be moved without opening any space in the downstream section. A sealing device 17 arranged between the extension 15 and the upper shoulder 16 ensures the absence of leak of the stream F.

As shown in FIGS. 2 to 5, each panel 10 is framed by a fixed section 18 extending the moving cowl 6 and ensuring the aerodynamic continuity of the downstream section when the panels 10 are in the cruise position. These fixed sections 18 each have lateral shoulders 19 capable of serving as supports for the panels 10. These lateral shoulders 19 may advantageously be equipped with sealing joints.

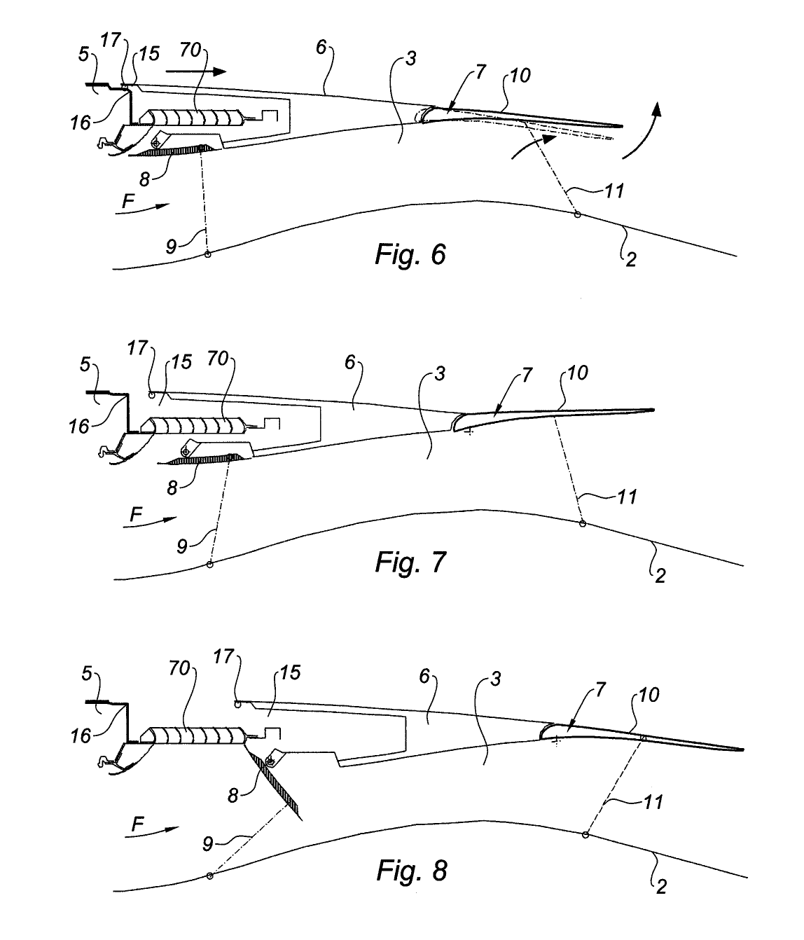

FIGS. 6 to 9 show different maneuvering positions of the panels 10 and the moving cowl 6.

In FIG. 6, the moving cowl 6 has been slightly reversed to increase the nozzle section 7. The small translation distance makes it possible to preserve the upstream sealing as previously explained.

The amplitude of the pivoting of the panels 10 as a function of the reversal distance will depend on the positioning of the link rod 11. By reversing the positioning of the link rod 11 (i.e. anchor point on the internal fairing structure 2 situated upstream from the anchor point of the link rod 11 in the panel 10), the pivoting will be done toward the inside of the nacelle, thereby reducing the nozzle section 7.

In FIG. 7, the moving cowl 6 is in the process of opening for a thrust reversal phase. During this transition phase, the nozzle section 7 panels 10 follow kinematics that offer a more significant opening than that sought in the adjustment mode of the nozzle.

This does not have any impact on the performance of the turbojet engine, because in this position, the upstream sealing is no longer ensured and part of the stream F is already reversed by the grids 70.

On the contrary, in this position, the external aerodynamics of the nacelle are greatly degraded, which improves the airplane's braking.

In FIG. 8, the moving cowl 6 is completely open, and the thrust reverser device is fully activated.

In this position, the panels 10 can be brought back into a position close to their cruise position in the direct thrust position.

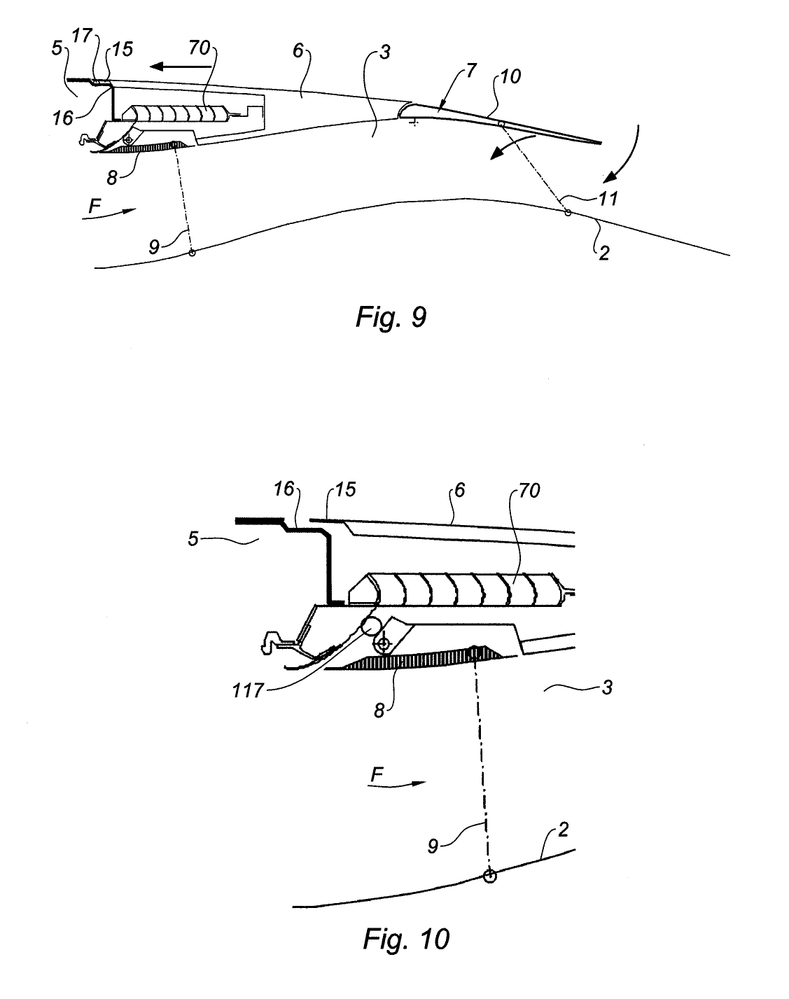

In FIG. 9, the moving cowl 6 is over-retracted, i.e. maneuvered in the upstream direction beyond its normal closing position, which causes a pivoting of the panel 10 toward the inside of the tunnel, and therefore a reduction of the nozzle section.

It should be noted that the link rod 11 has a significant impact on the pivoting of the corresponding panel 10. The slightest movement of the moving cowl 6 acts on the rotation of the panels 10. Thus, in order to facilitate the adaptation of the panels 10 and their correct positioning in the cruise position, the link rod 11 may be provided so that its length is adjustable, and/or so that it is adjustable longitudinally or transversely.

The adjustment of the length of the link rod may be done using the link rod itself or by adjusting anchor points on the panels 10 and the internal fairing structure 2.

FIGS. 10 to 12 show different embodiments of the upstream sealing between the moving cowl 6 and the front frame 5.

FIG. 10 shows a sealing device 117 arranged below the deflection grids 70 toward the inside of the downstream section. Such an arrangement makes it possible not to pressurize the inside of the moving cowl 6.

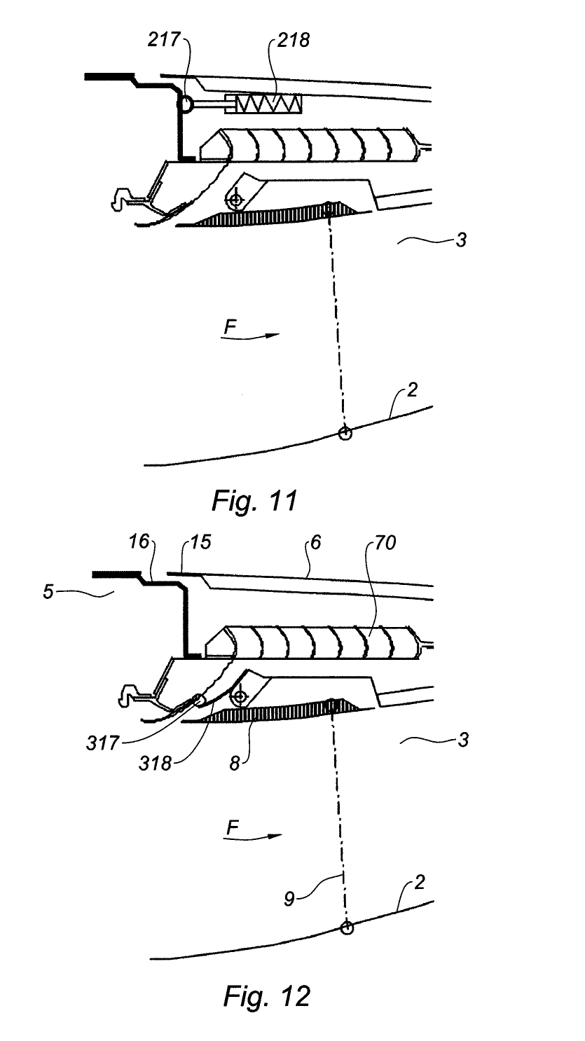

FIG. 11 shows an active upstream sealing comprising a device 217 mounted on an elastic return means 218 that keeps it in contact with the front frame over the entire adjustment distance. One advantage of this system lies in the collapsing quality of the device 217, which is direct and continuous and no longer sliding as in the case of the device 17.

FIG. 12 shows another embodiment of an active upstream sealing, this time arranged below deflection grids 70, which makes it possible not to pressurize the inside of the moving cowl 6. This sealing system comprises a device 317 mounted on an elastic return member 318 supported by an internal portion of the moving cowl 6. The elastic member 318 keeps the joint 317 against the front frame 5 during the phase for adjusting the nozzle section.

Of course, the invention is not limited only to the embodiments of this nacelle described above as examples, but on the contrary encompasses all variations. In particular, the moving nozzle could be connected to a smooth nacelle and not a nacelle equipped with a thrust reverser.

1. A bypass turbojet engine nacelle comprising a downstream section equipped with a thrust reverser device comprising a moving cowl mounted such that the cowl can move in translation in a direction substantially parallel to a longitudinal axis of the nacelle and able to move alternately from a closed position in which the cowl ensures the aerodynamic continuity of the nacelle and covers deflection means and an open position in which the cowl opens a passage in the nacelle and uncovers the deflection means, said moving cowl also being extended by at least one nozzle section mounted at a downstream end of said moving cowl, wherein the nozzle section comprises at least one panel mounted such that the panel can rotate about at least one pivot about an axis substantially perpendicular to a longitudinal axis of the nacelle, said panel further being connected to a fixed fairing structure of the turbojet engine by at least one link rod mounted such that it can rotate about anchor points on the panel of the nozzle section and on the fixed structure, respectively.

2. The nacelle according to claim 1, wherein the link rod is mounted obliquely such that one end of said link rod connected to the panel is upstream from an end connected to the fixed structure when the panel is in a cruise position, causing an increase in the nozzle section when the moving cowl is withdrawn.

3. The nacelle according to claim 1, wherein the link rod is mounted obliquely such that one end of said rod connected to the panel is downstream from an end connected to the fixed structure when the panel is in a cruise position, causing a reduction of the nozzle section when the moving cowl is withdrawn.

4. The nacelle according to claim 1, wherein it comprises between four and eight pivoting panels of moving nozzle section.

5. The nacelle according to claim 4, wherein the articulation of the panel of the pivoting nozzle section is defined in a thickness of streamlines of the downstream end of the moving cowl.

6. The nacelle according to claim 4, wherein each panel is articulated around two link rods each connected to said panel of the nozzle section via an articulation point, the two articulation points being spaced apart from each other by a distance substantially corresponding to two thirds of a width of said panel of the moving nozzle section.

7. The nacelle according to claim 1, wherein at least one portion of the nozzle section has a downstream trimming formed by chevrons.

8. The nacelle according to claim 1, wherein the moving cowl is extended by a fixed section on each side of each panel of the moving nozzle section, said fixed section being designed to ensure continuity of streamlines of the downstream section when the panel of the nozzle section is in a cruise position.

9. The nacelle according to claim 7, wherein said fixed section has at least one lateral shoulder designed to serve as a support for the corresponding panel of the moving nozzle section.

10. The nacelle according to claim 8, wherein the fixed section comprises sealing means with each corresponding moving nozzle section panel.

11. The nacelle according to claim 1, wherein a length of the link rod of the nozzle section panel at a fairing structure of the turbojet engine is adjustable.

12. The nacelle according to claim 1, wherein at least one anchor point of the link rod of the nozzle section panel at a fairing structure of the turbojet engine is adjustable along at least one axial direction of the link rod, and possibly along longitudinal and transverse directions of the nacelle.
